(19) United States
(12) Patent Application Publication
(10) Pub. No.: US 2008/0211707 A1
(43) Pub. Date: Sep. 4, 2008

(54) Slider-Activated Remote Controller for a Vehicle

(76) Inventor: Jung-Woo Park, Seoul (KR)

Correspondence Address: Invent Capture, LLC, 3319 Foxtail Terrace, Fremont, CA, 94536, US

(21) Appl. No.: 11/970,524

(22) Filed: Jan. 8, 2008

(30) Foreign Application Priority Data
Jan. 9, 2007 (KR) 20-2007-0000364

(51) Int. Cl. H04L 17/02

(52) U.S. Cl. 341/176

(57) ABSTRACT

A slider-activated vehicle remote controller incorporates a sliding mechanism to enable locking and/or unlocking of a vehicle. Either a straight-path slide movement or an axis-based slide movement can be used as the sliding mechanism for the slider-activated vehicle remote controller, wherein a direction of the sliding movement or a particular position of the sliding mechanism of the slider-activated vehicle remote controller can be configured to indicate the vehicle's locked and/or unlocked status. Therefore, by looking at the current shape of the slider-activated vehicle remote controller, a user can readily identify whether the vehicle is locked or unlocked. In one embodiment of the invention, the sliding mechanism acts as a switch to trigger locking and/or unlocking of the vehicle. In another embodiment of the invention, the sliding mechanism activates an underlying switch to trigger locking and/or unlocking of the vehicle.

### FOREIGN-PRIORITY CLAIM

This application claims foreign-priority to a Korean Intellectual Property Office utility patent application filed on Jan. 9, 2007, which successfully received a notice of allowance on Nov. 22, 2007. The application number of this foreign priority application is 20-2007-0000364.

### BACKGROUND

Wireless vehicle remote controllers have gained popularity in the last few decades and are increasingly becoming standard equipment for new automobiles to lock and/or unlock doors. Once a novelty among luxury cars, vehicle remote controllers have since proliferated to midsize and compact cars and have become substantially cheaper to implement in a variety of automobiles.

Before the widespread use of vehicle remote controllers, car owners generally had to insert a car key into a key hole and rotate the car key clockwise or counter clockwise. Alternative solutions included a keypad located outside of the car for password press, which reduced user inconvenience of inserting the car key into the key hole. However, vehicle remote controllers, which are typically implemented by radio-frequency (RF) signal encoding and decoding schemes, provide desirable user convenience and security that many users come to expect from modern automobiles.

There are many types of vehicle remote controllers in the market today. For example, in some automobiles equipped with wireless vehicle remote controllers, if a user attempts to unlock a car by turning a key in a keyhole without pressing a door unlock button from the car's remote controller, the car's alarm will go off to provide a maximum security to the car. Furthermore, many of today's vehicle remote controllers are also capable of starting a car's engine remotely, opening the car's trunk, and activating or deactivating alarms. Some are even equipped with liquid crystal display (LCD) to check the current status of the car from potential burglars remotely. However, vehicle remote controllers with LCD's tend to drive up the cost of manufacturing each key fob and suffer from short battery life.

The present inventor has previously filed for and granted a utility model application in South Korea (Korean Intellectual Property Office Utility Model Number: 20-0417257), in part to resolve shortcomings of the LCD-based vehicle remote controllers. This issued utility model disclosed a vehicle remote cover which encapsulated a conventional vehicle remote controller to provide a visual cue for locked and/or unlocked status of a car by changing a physical position of some portions of the vehicle remote cover. Therefore, the Korean Utility Model 20-0417257 disclosed means to provide visual indications for locked and/or unlocked state of a vehicle without necessitating a power-hungry display screen anywhere on a vehicle remote controller.

Nevertheless, the Korean Utility Model 20-0417257 has to be custom-made for each vehicle remote controller for proper encapsulation due to varying sizes, shapes, and configurations of vehicle remote controllers. Therefore, instead of a mere vehicle remote controller cover, a complete and cost-effective vehicle remote controller apparatus which provides visual cues for a variety of wireless commands to a vehicle, including lock or unlock commands for a door, can be highly useful in the vehicle remote controller market.

### SUMMARY

A slider-activated vehicle remote controller comprising a base unit configured to form a first exterior portion of the slider-activated vehicle remote controller, a switching element configured to transmit a wireless command to a vehicle, an electrical circuit board configured to contain the switching element and other electronic components, a switch activator configured to trigger the switching element to transmit the wireless command to the vehicle, and a slider configured to provide a slide movement adjacent to the base unit, wherein the slider forms a second exterior portion of the slider-activated vehicle remote controller.

### BRIEF DESCRIPTION OF DRAWINGS

FIG. 1a shows a top view of a slider-activated vehicle remote controller, in accordance with an example of the invention.

FIG. 1b shows another top view of a slider-activated vehicle remote controller, in accordance with an example of the invention.

FIG. 2a shows a cross-section of a first slider-activated vehicle remote controller, in accordance with a first embodiment of the invention.

FIG. 2b shows another cross-section of the first slider-activated vehicle remote controller, in accordance with the first embodiment of the invention.

FIG. 2c shows another cross-section of the first slider-activated vehicle remote controller, in accordance with the first embodiment of the invention.

FIG. 2d shows another cross-section of the first slider-activated vehicle remote controller, in accordance with the first embodiment of the invention.

FIG. 2e shows another cross-section of the first slider-activated vehicle remote controller, in accordance with the first embodiment of the invention.

FIG. 3a shows a cross-section of a second slider-activated vehicle remote controller, in accordance with a second embodiment of the invention.

FIG. 3b shows another cross-section of the second slider-activated vehicle remote controller, in accordance with the second embodiment of the invention.

FIG. 3c shows another cross-section of the second slider-activated vehicle remote controller, in accordance with the second embodiment of the invention.

FIG. 3d shows another cross-section of the second slider-activated vehicle remote controller, in accordance with the second embodiment of the invention.

FIG. 3e shows another cross-section of the second slider-activated vehicle remote controller, in accordance with the second embodiment of the invention.

FIG. 4a shows a cross-section of a third slider-activated vehicle remote controller, in accordance with a third embodiment of the invention.

FIG. 4b shows another cross-section of the third slider-activated vehicle remote controller, in accordance with the third embodiment of the invention.

FIG. 4c shows another cross-section of the third slider-activated vehicle remote controller, in accordance with the third embodiment of the invention.

FIG. 4d shows another cross-section of the third slider-activated vehicle remote controller, in accordance with the third embodiment of the invention.

FIG. 4e shows another cross-section of the third slider-activated vehicle remote controller, in accordance with the third embodiment of the invention.

FIG. 5a shows a cross-section of a fourth slider-activated vehicle remote controller, in accordance with a fourth embodiment of the invention.

FIG. 5b shows another cross-section of the fourth slider-activated vehicle remote controller, in accordance with the fourth embodiment of the invention.

FIG. 6a shows a cross-section of a fifth slider-activated vehicle remote controller, in accordance with a fifth embodiment of the invention.

FIG. 6b shows another cross-section of the fifth slider-activated vehicle remote controller, in accordance with the fifth embodiment of the invention.

FIG. 6c shows another cross-section of the fifth slider-activated vehicle remote controller, in accordance with the fifth embodiment of the invention.

FIG. 6d shows another cross-section of the fifth slider-activated vehicle remote controller, in accordance with the fifth embodiment of the invention.

FIG. 6e shows another cross-section of the fifth slider-activated vehicle remote controller, in accordance with the fifth embodiment of the invention.

FIG. 7 shows a cross-section of a sixth slider-activated vehicle remote controller, in accordance with a sixth embodiment of the invention.

FIG. 8 shows an exterior top view of a rectangular slider-activated vehicle remote controller, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relate to vehicle remote controllers. More specifically, embodiments of the invention disclose a slider-activated vehicle remote controller configured to issue a wireless command to a vehicle by varying positions of a straight-path-moving sliding mechanism, herein defined as a “sliding-type slider”. Furthermore, embodiments of the invention also disclose a slider-activated rotating-type vehicle remote controller configured to issue a wireless command to a vehicle by varying rotating positions of a sliding mechanism, herein defined as a “rotating-type slider”. In one embodiment of the invention, the wireless command is either an “unlock” or a “lock” command for the vehicle's door.

One aspect of the invention comprises a base unit for a slider-activated vehicle remote controller, a sliding-type or rotating-type slider sharing a common contact surface and an axis of movement with the base unit, an electrical circuitry configured to generate a wireless command, and a switching element triggering the wireless command transmitted to a vehicle. In one embodiment of the invention, a position change of the sliding-type or rotating-type slider triggers the wireless command to the vehicle. Furthermore, in one embodiment of the invention, the wireless command is either unlocking or locking of the vehicle's door.

Another aspect of the invention further comprises a “return-position” mechanism for a sliding-type or rotating-type slider on a base unit of the slider-activated vehicle remote controller. In one embodiment of the invention, after the sliding-type or rotating-type slider moves to a particular position to trigger a wireless command, the return-position mechanism brings the position of the sliding-type or rotating-type slider back to an original position or an “equilibrium” position of the slider-activated vehicle remote controller. In one embodiment of the invention, the return-position mechanism ensures that a switching element triggered by the movement of the sliding-type or rotating-type slider to the particular position does not remain active after the trigger. Because the switching element remaining switched “on” is undesirable for some situations (e.g. excessive energy consumption) during operation of the slider-activated vehicle remote controller, the return-position mechanism is highly desirable.

Another aspect of the invention further comprises a position-fixing mechanism for a sliding-type or rotating-type slider on a base unit of the slider-activated vehicle remote controller. The position-fixing mechanism restricts free movements of the sliding-type or rotating-type slider and prevents inadvertent or unwanted triggering of a wireless command to a vehicle. In one embodiment of the invention, the wireless command is either unlocking or locking of the vehicle's door.

Another aspect of the invention further comprises a timer unit incorporated into an electrical circuitry and/or a switching element of the slider-activated vehicle remote controller. In one embodiment of the invention, the timer unit is configured to limit the amount of active time of the switching element triggering a wireless command transmitted to a vehicle. Furthermore, in one embodiment of the invention, the wireless command is either unlocking or locking of the vehicle's door.

Another aspect of the invention further comprises a multiple number of wireless commands incorporated into the slider-activated vehicle remote controller. In one embodiment of the invention, the multiple number of wireless commands can include a trunk-opening command, a rear-door opening command, side-door opening command in case of a minivan or any other automobile with a side-door, a system reset command, and a panic-alarm activation command. Furthermore, in one embodiment of the invention, some of these commands can be implemented using buttons, hard switches, or other input means other than just a sliding-type or rotating-type slider.

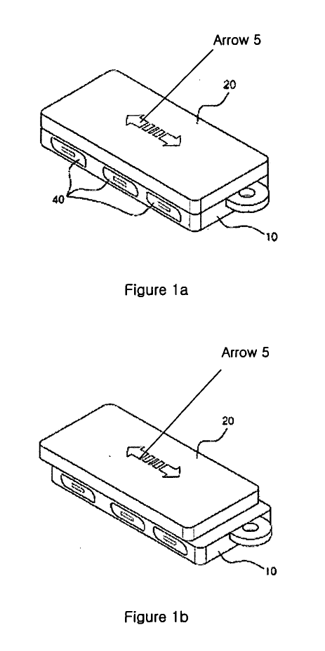

Several embodiments of the invention are disclosed in this specification with figures. FIG. 1a shows a top view of a slider-activated vehicle remote controller which incorporates a straight-path sliding movement. In one embodiment of the invention, the slider-activated vehicle remote controller as shown in FIG. 1a comprises a base unit (10), a sliding-type slider (20) in a first position with straight-path travel (Arrow 5) on top of the base unit (10), and a plurality of buttons (40) on a side of the base unit. FIG. 1b also shows a top view of a slider-activated vehicle remote controller which incorporates the sliding-type slider (20) in a second position with the same straight-path travel (Arrow 5) on top of the base unit (10). In one embodiment of the invention, the first position of the sliding-type slider (20) in FIG. 1a indicates that a vehicle's doors are locked and the second position of the sliding-type slider (20) in FIG. 1b indicates that the vehicle's doors are unlocked.

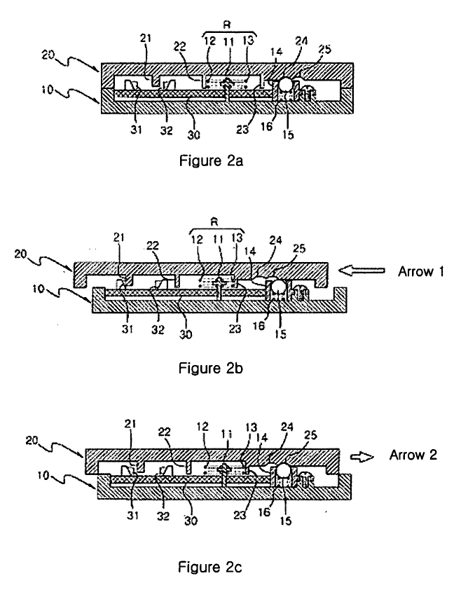

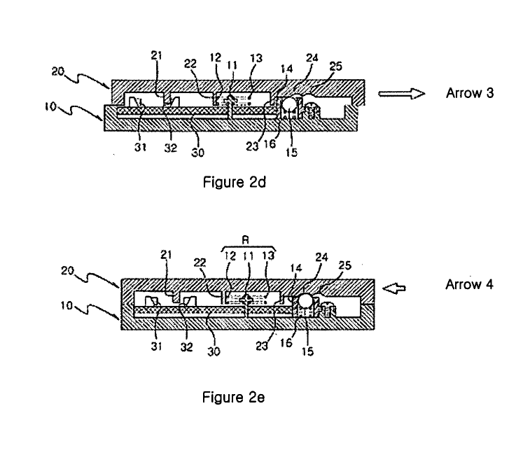

FIG. 2a˜2e show cross-sections of a first slider-activated vehicle remote controller, wherein FIGS. 2b˜2e show exemplary steps of the first slider-activated vehicle remote shown in FIG. 2a in accordance with a first embodiment of the invention. All of the drawings for FIG. 2a˜2e comprise a base unit (10), a sliding-type slider (20), an electrical circuit board (30) containing electrical circuitry, switching elements (31, 32), a return-position mechanism (11, 12, 13, 22, 23, R), and a position-fixing mechanism (14, 15, 16, 24, 25).

In FIG. 2a, an unlock switch (31) and a lock switch (32) located on top of the electrical circuit board (30) are shown. In one embodiment of the invention, the unlock switch (31) and the lock switch (32) are parallel to an axis of movement for the sliding-type slider (20) and face each other on the electrical circuit board (30). The unlock switch (31) and the lock switch (32) are configured to contact a switch activator (21) based on a horizontal sliding movement of the sliding-type slider (20). In one embodiment of the invention, the contact between the switch activator (21) and either the unlock switch (31) or the lock switch (32) further involves a pressing motion by the switch activator (21). This pressing motion can be used to activate a pressure sensor in the unlock switch (31) or the lock switch (32) to trigger a related wireless command to a vehicle.

The return-position mechanism (11, 12, 13, 22, 23, R) of FIG. 2a comprises a center return mechanism support (11) on the base unit (10), a first spring (12), a second spring (13), a first slide travel limiter (22), and a second slide travel limiter (23). In one embodiment of the invention, a movement of the sliding-type slider (20) forces either the first spring (12) or the second spring (13) to generate elastic potential energy against the center return mechanism support (11) and either the first slide travel limiter (22) or the second slide travel limiter (23), which is converted to kinetic energy to return the sliding-type slider (20) to its equilibrium or original position.

Continuing with FIG. 2a, the position-fixing mechanism (14, 15, 16, 24, 25) comprises a ball housing (14) located on top of the base unit (10), a ball (15) on top of ball-supporting springs (16), wherein a top portion of the ball (15) surfaces and protrudes above the ball housing (14), a first groove (24), and a second groove (25). In one embodiment of the invention, the first groove (24) and the second groove (25) are configured to receive and fit the top portion of the ball (15), which provides a stationary position to the sliding-type slider (20).

FIGS. 2b˜2e show exemplary operating steps of the first slider-activated vehicle remote controller of FIG. 2a. In FIG. 2b, the sliding-type slider (20) is horizontally pushed left (Arrow 1) from the equilibrium position shown in FIG. 2a. In one embodiment of the invention, the leftward movement of the sliding-type slider (20) causes the switch activator (21) to contact and press against the unlock switch (31), which triggers a wireless command for unlocking a vehicle door via electrical circuitry on the electrical circuit board (30). Furthermore, the leftward movement of the sliding-type slider (20) also causes the second slide travel limiter (23) to compress the second spring (13) of the return-position mechanism to build elastic potential energy. Moreover, the ball (15) in the ball housing (14), which was originally located underneath the first groove (24) in FIG. 2a, is now under a right side of the second groove (25) in FIG. 2b due to the leftward movement of the sliding-type slider (20). In the first slider-activated vehicle remote controller, the ball (15) also builds an upward elastic potential energy due to compressed ball-supporting springs (16) underneath the right side of the second groove (25).

FIG. 2c shows a next snapshot moment of the exemplary operating steps for the first slider-activated vehicle remote controller. After the wireless command for unlocking the vehicle door is triggered in FIG. 2b, if a user stops exerting force for the leftward movement of the sliding-type slider (20), the sliding-type slider (20) attempts to return to its equilibrium position of FIG. 2a because of the elastic potential energy built on the compressed second spring (13) of the return-position mechanism turns into a rightward kinetic energy (Arrow 2). However, the ball (15) is anchored by the second groove (25), thereby stopping the further rightward movement of the sliding-type slider (20) towards its equilibrium position. In one embodiment of the invention, the anchored position of the ball (15) to the second groove creates a visual cue (e.g. the sliding-type slider (20) is on a left offset position relative to the base unit (10) underneath) that the vehicle door is unlocked.

FIG. 2d shows another exemplary operating step for the first slider-activated vehicle remote controller, if the user desires to lock the vehicle door. In one embodiment of the invention, a rightward sliding force (Arrow 3) on the sliding-type slider (20) is required to lock the vehicle door, in contrast to a leftward sliding force (Arrow 1) required to unlock the vehicle door as shown in FIG. 2b. The rightward sliding force (Arrow 3) causes the switch activator (21) to contact and press against the lock switch (32) which triggers a wireless command for locking the vehicle door via electrical circuitry on the electrical circuit board (30). Furthermore, the rightward movement of the sliding-type slider (20) also causes the first slide travel limiter (22) to compress the first spring (12) of the return-position mechanism to build elastic potential energy. Moreover, the ball (15) in the ball housing (14), which was located underneath the second groove (25) in FIG. 2c, is now under a left side of the first groove (24) in FIG. 2d due to the rightward sliding force (Arrow 3) exerted to the sliding-type slider (20). In the first slider-activated vehicle remote controller, the ball (15) also builds an upward elastic potential energy due to compressed ball-supporting springs (16) underneath the left side of the first groove (24).

FIG. 2e shows another exemplary operating step for the first slider-activated vehicle remote controller. After the wireless command for locking the vehicle door is triggered in FIG. 2d, if the user stops exerting the rightward sliding force (Arrow 3 of FIG. 2d) on the sliding-type slider (20), the sliding-type slider (20) attempts to return to its equilibrium or original position as shown in FIG. 2e because the elastic potential energy built on the compressed first spring (12) of the return-position mechanism turns into a leftward kinetic energy (Arrow 4). With the sliding-type slider (20) moving towards left, the switch activator (21) releases contact with the lock switch (32) and the ball (15) locks onto the first groove (24), which stops the further leftward movement of the sliding-type slider (20) when it reaches its equilibrium position. In one embodiment of the invention, the equilibrium position is defined as a substantial non-offset contact between the sliding-type slider (20) and the base unit (10) as shown in FIG. 2a and FIG. 2e, wherein the substantial non-offset contact means that the sliding-type slider (20) is positioned on top of the base unit (10) without any substantial sidewall misalignments. In one embodiment of the invention, this substantial non-offset contact between the sliding-type slider (20) and the base unit (10) at the equilibrium position creates a visual cue that the vehicle door is locked, which contrasts with the anchored left offset position of the sliding-type slider (20) relative to the base unit (10) when the unlock command is performed, as shown in FIG. 2c.

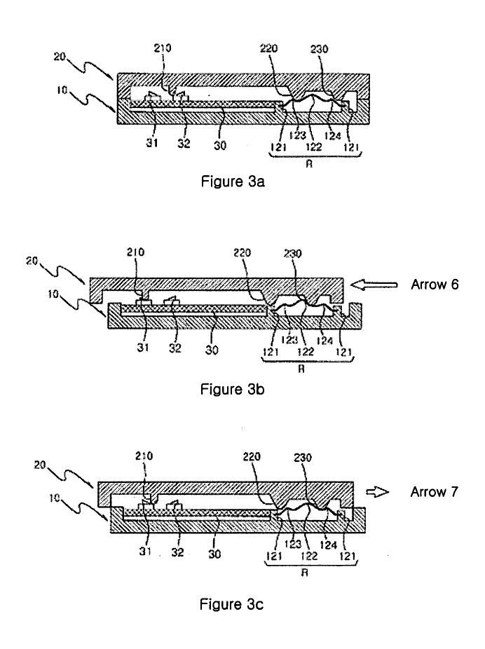

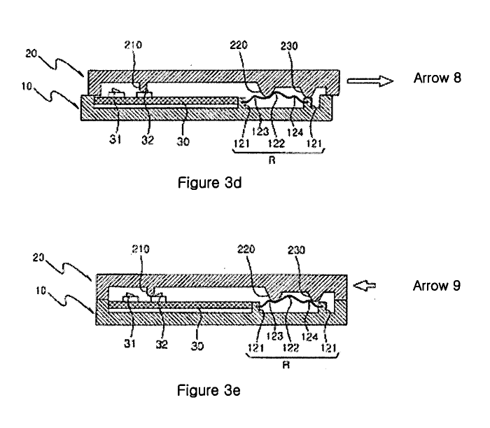

FIG. 3a˜3e show cross-sections of a second slider-activated vehicle remote controller, wherein FIGS. 3b˜3e show exemplary steps of the second slider-activated vehicle remote shown in FIG. 3a in accordance with a second embodiment of the invention. All of the drawings for FIG. 3a˜3e comprise a base unit (10), a sliding-type slider (20), an electrical circuit board (30), switching elements (31, 32), a hybrid return-position and position-fixing mechanism (121, 122, 123, 124, 220, 230, R).

In FIG. 3a, an unlock switch (31) and a lock switch (32) located on top of the electrical circuit board (30) are shown. In one embodiment of the invention, the unlock switch (31) and the lock switch (32) are parallel to an axis of movement for the sliding-type slider (20) and face each other on the electrical circuit board (30). The unlock switch (31) and the lock switch (32) are configured to contact a switch activator (210) based on a horizontal sliding movement of the sliding-type slider (20). In one embodiment of the invention, the contact between the switch activator (210) and either the unlock switch (31) or the lock switch (32) further involves a pressing motion by the switch activator (210). This pressing motion can be used to activate a pressure sensor in the unlock switch (31) or the lock switch (32) to trigger a related wireless command to a vehicle.

The hybrid return-position and position-fixing mechanism (121, 122, 123, 124, 220, 230, R) of FIG. 3a comprises a pair of base support elements (121) attached to the base unit (10), three stops (122, 123, 124) on a slider-stop element attached to the pair of base support elements (121), and two slider anchors (220, 230) on a bottom side of the sliding-type slider (20). In one embodiment of the invention, a horizontal movement of the sliding-type slider (20) latches either a first slider anchor (220) or a second slider anchor (230) to one of the three stops (122, 123, 124) on the slider-stop element attached to the pair of base support elements (121).

FIGS. 3b˜3e show exemplary operating steps of the second slider-activated vehicle remote controller of FIG. 3a. In FIG. 3b, the sliding-type slider (20) is horizontally pushed left (Arrow 6) from an initial position shown in FIG. 3a. In one embodiment of the invention, the leftward movement of the sliding-type slider (20) causes the switch activator (210) to contact and press against the unlock switch (31), which triggers a wireless command for unlocking a vehicle door via electrical circuitry on the electrical circuit board (30). Furthermore, the leftward movement of the sliding-type slider (20) also causes the second slider anchor (230) to compress a right-side slope of a first stop (122) after passing a third stop (124) on the slider stop element to build elastic potential energy.

FIG. 3c shows a next snapshot moment of the exemplary operating steps for the second slider-activated vehicle remote controller. After the wireless command for unlocking the vehicle door is triggered in FIG. 3b, if a user stops exerting force for the leftward movement of the sliding-type slider (20), the sliding-type slider (20) attempts to return to its initial position of FIG. 3a because the elastic potential energy built on the right-side slope of the first stop (122) by the second slider anchor (230) turns into a rightward kinetic energy (Arrow 7). However, the second slider anchor (230) is anchored by the third stop (124) on the slider-stop element, which stops further rightward movement of the sliding-type slider (20) towards its initial position of FIG. 3a. In one embodiment of the invention, the anchored position of the second slider anchor (230) by the third stop (124) on the slider-stop element creates a visual cue (e.g. the sliding-type slider (20) is on a left offset position relative to the base unit (10) underneath) that the vehicle door is unlocked.

FIG. 3d shows another exemplary operating step for the second slider-activated vehicle remote controller, if the user desires to lock the vehicle door. In one embodiment of the invention, a rightward sliding force (Arrow 8) on the sliding-type slider (20) is required to lock the vehicle door, in contrast to a leftward sliding force (Arrow 6) required to unlock the vehicle door as shown in FIG. 3b. The rightward sliding force (Arrow 8) causes the switch activator (210) to contact and press against the lock switch (32) which triggers a wireless command for locking the vehicle door via electrical circuitry on the electrical circuit board (30). Furthermore, the rightward movement of the sliding-type slider (20) also causes the first slider anchor (220) to compress a left-side slope of the first stop (122) on the slider stop element to build elastic potential energy.

FIG. 3e shows another exemplary operating step for the second slider-activated vehicle remote controller. After the wireless command for locking the vehicle door is triggered in FIG. 3d, if the user stops exerting the rightward sliding force (Arrow 8 of FIG. 3d) on the sliding-type slider (20), the sliding-type slider (20) attempts to return to its initial position as shown in FIG. 3e because the elastic potential energy built on the compressed left-side slope of the first stop (122) on the slider stop element by the first slider anchor (220) of FIG. 3d turns into a leftward kinetic energy (Arrow 9) in FIG. 3e. With the sliding-type slider (20) moving towards left, the switch activator (210) releases contact with the lock switch (32) and the first slider anchor (220) is anchored by a second stop (123) on the slider stop element, which stops the further leftward movement of the sliding-type slider (20) when it reaches its initial position. In one embodiment of the invention, the initial position is defined as a substantial non-offset contact between the sliding-type slider (20) and the base unit (10) as shown in FIG. 3a and FIG. 3e, wherein the substantial non-offset contact means that the sliding-type slider (20) is positioned on top of the base unit (10) without any substantial sidewall misalignments. In one embodiment of the invention, this substantial non-offset contact between the sliding-type slider (20) and the base unit (10) at the initial position creates a visual cue that the vehicle door is locked, which contrasts with the anchored left offset position of the sliding-type slider (20) relative to the base unit (10) when the unlock command is performed, as shown in FIG. 3c.

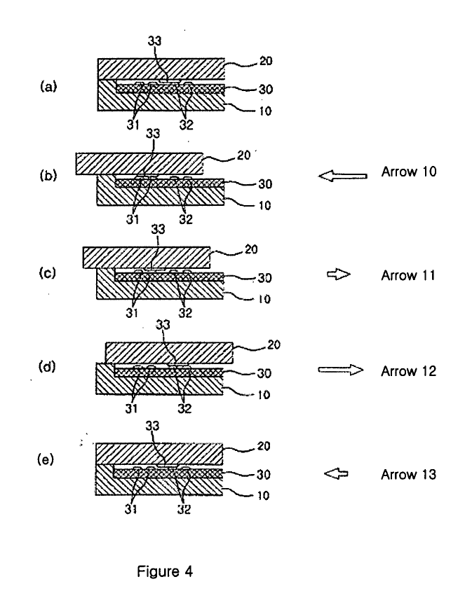

FIG. 4a˜4e show cross-sections of a third slider-activated vehicle remote controller, wherein FIGS. 4b˜4e show exemplary steps of the third slider-activated vehicle remote shown in FIG. 4a in accordance with a third embodiment of the invention. All of the drawings for FIG. 4a˜4e comprise a base unit (10), a sliding-type slider (20), an electrical circuit board (30), switching elements (31, 32), and a return-position and position-fixing mechanism substantially similar to the mechanisms described for the first two embodiments of the invention as shown in FIG. 2a˜2e and FIG. 3a˜3e.

FIG. 4a shows one embodiment of the third slider-activated vehicle remote controller, with an unlock switch (31) comprising a pair of unlock switch junctions, a lock switch (32) comprising a pair of lock switch junctions, a base unit (10), and a junction connector (33) attached to a bottom surface of the sliding-type slider (20). In one embodiment of the invention, the junction connector (33), the pair of unlock switch junctions for the unlock switch (31), and the pair of lock switch junctions for the lock switch (32) are made of electrically conductive material such as copper to use electricity as a method of switching. In another embodiment of the invention, the junction connector (33), the pair of unlock switch junctions for the unlock switch (31), and the pair of lock switch junctions for the lock switch (32) are made of ferromagnetic materials to use magnetism as another method of switching.

FIGS. 4b˜4e show exemplary operating steps of the third slider-activated vehicle remote controller of FIG. 4a. In FIG. 4b, the sliding-type slider (20) is horizontally pushed left (Arrow 10) from an initial position shown in FIG. 4a. In one embodiment of the invention, the leftward movement of the sliding-type slider (20) causes the junction connector (33) to contact the pair of unlock switch junctions for the unlock switch (31), which triggers a wireless command for unlocking a vehicle door via electrical circuitry on the electrical circuit board (30). In one embodiment of the invention, the junction connector (33) is electrically conductive and provides an electrical connection to the pair of unlock switch junctions for the unlock switch (31) at the moment depicted in FIG. 4b. In another embodiment of the invention, the junction connector (33) is magnetically active and provides a magnetic connection to the pair of unlock switch junctions for the unlock switch (31) at the moment depicted in FIG. 4b.

FIG. 4c shows a new anchored position of the sliding-type slider (20) in accordance with the third embodiment of the invention. When a user stops exerting the leftward force (Arrow 10) on the sliding-type slider (20) because the wireless command for unlocking the vehicle is already executed, the sliding-type slider (20) moves slightly rightward (Arrow 11) using any previously-described return-position and/or position-fixing mechanisms (i.e. FIG. 2a˜2e and FIG. 3a˜3e). This slightly-rightward movement will cause the junction connector (33) to disconnect from the pair of unlock switch junctions for the unlock switch (31). The sliding-type slider (20) is able to stay in its new anchored position by using previously described position-fixing mechanisms. In one embodiment of the invention, this new anchored position creates a visual cue (e.g. the sliding-type slider (20) is on a left offset position relative to the base unit (10) underneath) that the vehicle door is unlocked.

FIG. 4d shows another exemplary operating step for the third slider-activated vehicle remote controller, if the user desires to lock the vehicle door. In one embodiment of the invention, a rightward sliding force (Arrow 12) on the sliding-type slider (20) is required to lock the vehicle door, in contrast to a leftward sliding force (Arrow 10) required to unlock the vehicle door as shown in FIG. 4b. The rightward sliding force (Arrow 12) on the sliding-type slider (20) causes the junction connector (33) to contact the pair of lock switch junctions for the lock switch (32), which triggers a wireless command for locking a vehicle door via electrical circuitry on the electrical circuit board (30). In one embodiment of the invention, the junction connector (33) is electrically conductive and provides an electrical connection to the pair of lock switch junctions for the lock switch (32) at the moment depicted in FIG. 4d. In another embodiment of the invention, the junction connector (33) is magnetically active and provides a magnetic connection to the pair of lock switch junctions for the lock switch (33) at the moment depicted in FIG. 4d.

FIG. 4e shows another exemplary operating step for the third slider-activated vehicle remote controller. After the wireless command for locking the vehicle door is triggered in FIG. 4d, if the user stops exerting the rightward sliding force (Arrow 12 of FIG. 4d) on the sliding-type slider (20), the sliding-type slider (20) attempts to return to its initial position as shown in FIG. 4e using previously-described return-position and position-fixing mechanisms (i.e. FIG. 2a˜2e and FIG. 3a˜3e).

The sliding-type slider (20) moves slightly leftward (Arrow 13) using any previously-described return-position and/or position-fixing mechanisms. This slightly-leftward movement (Arrow 13) will cause the junction connector (33) to disconnect from the pair of lock switch junctions for the lock switch (32). In one embodiment of the invention, the sliding-type slider (20) has returned to its initial position of FIG. 4a using any previously-described return-position and/or position-fixing mechanisms. In one embodiment of the invention, the initial position is defined as a substantial non-offset contact between the sliding-type slider (20) and the base unit (10) as shown in FIG. 4a and FIG. 4e, wherein the substantial non-offset contact means that the sliding-type slider (20) is positioned on top of the base unit (10) without any substantial sidewall misalignments. In one embodiment of the invention, this substantial non-offset contact between the sliding-type slider (20) and the base unit (10) at the initial position creates a visual cue that the vehicle door is locked, which contrasts with the anchored left offset position of the sliding-type slider (20) relative to the base unit (10) when the unlock command is performed, as shown in FIG. 4c.

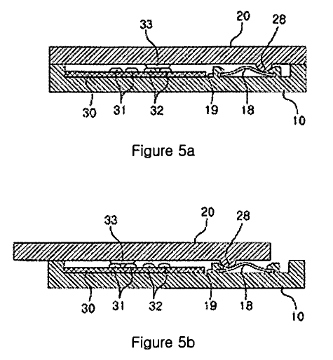

FIG. 5a˜5b show cross-sections of a fourth slider-activated vehicle remote controller in accordance with a fourth embodiment of the invention. The fourth slider-activated vehicle remote controller is designed without a return-position mechanism and comprises a base unit (10), a sliding-type slider (20), a slider anchor (28), switching elements (31, 32), an electrical circuit board (30), a pair of base support elements (19), an elastic slider rail (18), a junction connector (33) attached to the sliding-type slider (20), and a position-fixing mechanism.

FIG. 5a shows a snap-shot of a cross-section of the fourth slider-activated vehicle remote controller in accordance with the fourth embodiment of the invention, when a pair of lock switch junctions for the lock switch (32) makes an electrical contact with the junction connector (33). In one embodiment of the invention, the junction connector (33) enables the pair of lock switch junctions for the lock switch (32) to flow electricity when the sliding-type slider (20) is at a particular position (e.g. initial position as shown in FIG. 5a) to allow the junction connector (33) to make an electrical contact with both lock switch junctions for the lock switch (32). When this electrical contact is made, a wireless command for locking a vehicle is triggered.

FIG. 5b shows a snap-shot of a cross-section of the fourth slider-activated vehicle remote controller in accordance with the fourth embodiment of the invention, when a pair of unlock switch junctions for the unlock switch (31) makes an electrical contact with the junction connector (33). In one embodiment of the invention, the junction connector (33) enables the pair of unlock switch junctions for the unlock switch (31) to flow electricity when the sliding-type slider (20) is at a particular position (e.g. leftward as shown in FIG. 5b) to allow the junction connector (33) to make an electrical contact with both unlock switch junctions for the unlock switch (31). When this electrical contact is made, a wireless command for unlocking a vehicle is triggered. The elastic slider rail (18) attached to the pair of base support elements (19) makes the slider anchor (28) to find a position to anchor the sliding-type slider (20), as shown in FIG. 5b. The combined use of the elastic slider rail (18) and the slider anchor (28) form the position-fixing mechanism for the fourth embodiment of the invention. This simple position-fixing mechanism can also be used for other embodiments of the invention.

Because a return mechanism is not incorporated into the fourth slider-activated vehicle remote controller in accordance with the fourth embodiment of the invention, it is preferred to implement a timer circuit to stop a flow of electricity to connected switch junctions by the junction connector (33) after a certain duration of time has passed after the junction connection. The implementation of the timer circuit reduces battery consumption and strain placed in electrical circuitry on the electrical circuit board (30). The fourth embodiment of the invention is the inventor's preferred mode of design and operation.

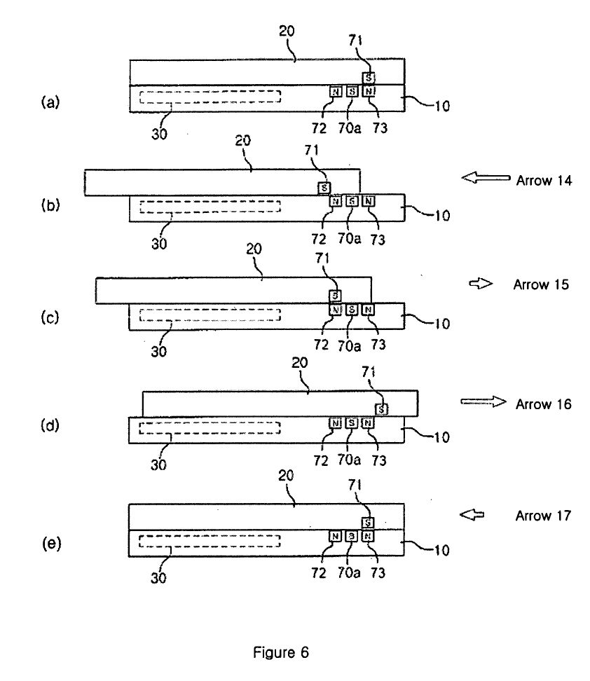

FIG. 6a˜6e show cross-sections of a fifth slider-activated vehicle remote controller, in accordance with a fifth embodiment of the invention. The fifth slider-activated vehicle remote controller uses a magnetic-based slider control system instead of elastic and mechanical-based slider control systems. The fifth slider-activated vehicle remote controller comprises a base unit (10), a sliding-type slider (20), a slider magnet (71) attached to the sliding-type slider, a first base magnet (72), a second base magnet (73), and an electrical circuit board (30) containing switching elements and other electronics for wires command transmission to a vehicle. Optionally, a pulse magnet (70a) can be placed between the first base magnet (72) and the second base magnet (73) to provide smoother movement of the sliding-type slider (20).

FIG. 6a shows a cross-section of the fifth slider-activated vehicle remote controller in an initial position. The initial position is anchored by a magnetic attraction between the slider magnet (71) and the second base magnet (73) which are opposite in polarity. In one embodiment of the invention, the slider magnet (71) is south and the first and the second base magnets (72, 73) are north in magnetic polarity.

In FIG. 6b, upon a leftward push (Arrow 14) of the sliding-type slider (20) by a user, the sliding-type slider slides past the first base magnet (72). However, the magnetic attraction between the slider magnet (71) and the first base magnet (72) pushes the sliding-type slider rightward (Arrow 15) to a new stop position, anchored by the magnetic attraction, as shown in FIG. 6c. In one embodiment of the invention, this new stop position can be utilized for triggering an “unlock” wireless command to a vehicle by turning an unlock switch active.

FIG. 6d shows a rightward push (Arrow 16) by the user, which can be used to issue a new wireless command to a vehicle. In a snapshot moment of FIG. 6d, the slider magnet (71) initially glides past the second base magnet (73). Similar to the magnetic attraction shown in FIG. 6b˜6c, the sliding-type slider (20) experiences a new magnetic attraction between the slider magnet (71) and the second base magnet (73), which creates a leftward push by magnetic forces (Arrow 17) as shown in FIG. 6e. The sliding-type slider (20) returns to the initial position anchored by the magnetic forces between the slider magnet (71) and the second base magnet (73). In one embodiment of the invention, returning to the initial position can be utilized for triggering a “lock” wireless command to a vehicle by turning a lock switch active. The magnetic-based slider control system disclosed in the fifth embodiment of the invention can replace previously mentioned return-position mechanisms and/or position-fixing mechanisms in other embodiments.

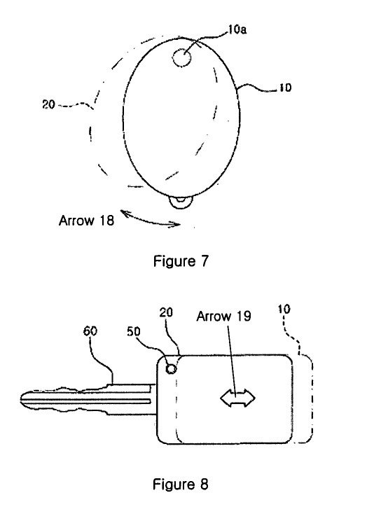

FIG. 7 shows a cross-section of a sixth slider-activated vehicle remote controller, in accordance with a sixth embodiment of the invention. The sixth slider-activated vehicle remote controller is rotating-type instead of sliding-type. The sixth slider-activated vehicle remote controller comprises a base unit (10) and a rotating-type slider (20) which is configured to rotate around a sliding axis (10a), as shown by Arrow 18. Previously described switching elements, return-position mechanisms, position-fixing mechanisms, magnetic-based slider control systems, and all other relevant apparatuses and methods can apply to rotating-type vehicle remote controllers. Furthermore, shapes of interior electrical circuit board and any related electronic components' locations within the sixth slider-activated vehicle remote controller can adjust according to an exterior shape of the sixth slider-activated vehicle remote controller.

FIG. 8 shows an exterior top view of a rectangular slider-activated vehicle remote controller, in accordance with an embodiment of the invention. The rectangular slider-activated vehicle remote controller comprises a base-unit (10), a sliding-type slider (20), an optional light-emitting diode (LED), and a key frame (60) In one embodiment of the invention, the base-unit (10), the key frame (60), and the sliding-type slider (20) can be manufactured by utilizing a conventional plastic injection molding technique. In one embodiment of the invention, the optional light-emitting diode (LED) can be used as a lock or unlock indicator. A multiple number of LED's or any other display means such as liquid crystal displays (LCD's) can be used as necessary to reduce the present invention to practice.

The present invention embodies a cost-effective, slider-activated vehicle remote controller which provides visual cues for a variety of wireless commands to a vehicle, including lock or unlock command for a vehicle door. While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A slider-activated vehicle remote controller comprising:
a base unit configured to form a first exterior portion of the slider-activated vehicle remote controller;
a switching element configured to transmit a wireless command to a vehicle;
an electrical circuit board configured to contain the switching element and other electronic components;
a switch activator configured to trigger the switching element to transmit the wireless command to the vehicle; and
a slider configured to provide a slide movement adjacent to the base unit, wherein the slider forms a second exterior portion of the slider-activated vehicle remote controller.

2. The slider-activated vehicle remote controller of claim 1, wherein the first exterior portion and the second exterior portion largely constitutes an outer shape of the slider-activated vehicle remote controller.

3. The slider-activated vehicle remote controller of claim 1, wherein the slider is a sliding-type slider.

4. The slider-activated vehicle remote controller of claim 1, wherein the slider is a rotating-type slider.

5. The slider-activated vehicle remote controller of claim 1, wherein the switch activator is attached to a bottom surface of the slider.

6. The slider-activated vehicle remote controller of claim 1, further comprising a first return-position mechanism for the slider, wherein the first return-position mechanism comprises a center return mechanism support, a first spring, a second spring, a first slide travel limiter, and a second slide travel limiter.

7. The slider-activated vehicle remote controller of claim 1, further comprising a first position-fixing mechanism for the slider, wherein the position-fixing mechanism comprises a ball housing, a ball largely located inside the ball housing, ball-supporting springs underneath the ball, a first groove on the slider, and a second groove on the slider.

8. The slider-activated vehicle remote controller of claim 1, further comprising a hybrid return-position and position-fixing mechanism for the slider, wherein the hybrid return-position and position-fixing mechanism comprises a first base support element, a first stop of a slider-stop element held by the first base support element, a second stop of the slider-stop element held by the first base support element, a third stop of the slider-stop element held by the first base support element, a first slider anchor on the slider, and a second slider anchor on the slider.

9. The slider-activated vehicle remote controller of claim 1, further comprising a second position-fixing mechanism for the slider, wherein the position-fixing mechanism comprises a second base support element, an elastic slider rail held by the second base support element, and a third slider anchor on the slider.

10. The slider-activated vehicle remote controller of claim 1, further comprising a magnetic-based slider control system, wherein the magnetic-based slider control system comprises a slider magnet located in the slider, a first base magnet located in the base unit, and a second base magnet located in the base unit, wherein the slider magnet has an opposite magnetic polarity relative to the first base magnet and the second base magnet.

11. The magnetic-based slider control system of claim 10, further comprising a pulse magnet located in the base unit, wherein the pulse magnet is configured to provide a smoother movement of the sliding-type slider.

12. The slider-activated vehicle remote controller of claim 1, wherein the slide movement is a straight-path movement.

13. The slider-activated vehicle remote controller of claim 1, wherein the slide movement is an axis-based rotational movement.

14. The slider-activated vehicle remote controller of claim 1, further comprising a key frame, wherein the key frame is plastic injection-molded with the base unit or the slider.

15. The slider-activated vehicle remote controller of claim 1, further comprising a display, wherein the display can indicate a certain status for the wireless command or the vehicle.

16. The slider-activated vehicle remote controller of claim 1, wherein the wireless command is an “unlock” command to the vehicle.

17. The slider-activated vehicle remote controller of claim 1, wherein the wireless command is a “lock” command to the vehicle.

18. The slider-activated vehicle remote controller of claim 1, further comprising a plurality of buttons located in the slider-activated vehicle remote controller, wherein the plurality of buttons are configured to issue additional wireless commands to the vehicle.

19. The slider-activated vehicle remote controller of claim 15, wherein the display is a light-emitting diode (LED).

20. The slider-activated vehicle remote controller of claim 15, wherein the display is a liquid crystal display (LCD).
